(19) United States
(12) Patent Application Publication
(10) Pub. No.: US 2021/0220763 A1
(43) Pub. Date: Jul. 22, 2021

(54) FILTER ELEMENT

(71) Applicant: A.L. FILTER EAD, Ruse (BG)

(72) Inventors: Huiying CHEN, Shanghai (CN); Sharon MILLMAN, Holon (IL); Yaakov BEN SHIMON, Rehovot (IL)

(73) Assignee: A.L. FILTER EAD, Ruse (BG)

(21) Appl. No.: 17/122,200

(22) Filed: Dec. 15, 2020

Related U.S. Application Data
(60) Provisional application No. 62/961,787, filed on Jan. 16, 2020.

(51) Int. Cl. B01D 29/58; B01D 29/11; B01D 29/23

(52) U.S. Cl. CPC B01D 29/58; B01D 2201/295; B01D 29/23; B01D 29/117

(57) ABSTRACT

A fluid filter element for use with a filter housing having a selectably blockable outlet channel for unfiltered fluid, the filter fluid element including first and second end caps, a filter medium joined to the first and second end caps and defining a cylindrical configuration arranged about a central bore extending between the first and second end caps, a water separator operative to separate water from filtered fluid, a water collector arranged for collecting water separated from the filter fluid and a plug mounted on the second end cap and separate from the water collector and being configured for selective blocking of the selectably blockable outlet channel, when the fluid filter element is mounted in the filter housing in an operative orientation.

### FIELD OF THE INVENTION

The present invention relates to fluid filters and more particularly to fuel filters such as diesel fuel filters.

### BACKGROUND OF THE INVENTION

Various types of fuel filters are known in the art. One example is described in U.S. Pat. No. 9,333,448, the disclosure of which is hereby incorporated by reference.

### SUMMARY OF THE INVENTION

The present invention seeks to provide an improved fluid filter. There is thus provided in accordance with a preferred embodiment of the present invention a fluid filter element for use with a filter housing having a selectably blockable outlet channel for unfiltered fluid, the filter fluid element including first and second end caps, a filter medium joined to the first and second end caps and defining a cylindrical configuration arranged about a central bore extending between the first and second end caps, a water separator operative to separate water from filtered fluid, a water collector arranged for collecting water separated from the filter fluid and a plug mounted on the second end cap and separate from the water collector and being configured for selective blocking of the selectably blockable outlet channel, when the fluid filter element is mounted in the filter housing in an operative orientation.

There is also provided in accordance with another preferred embodiment of the present invention a fluid filter element including first and second end caps, a filter medium joined to the first and second end caps and defining a cylindrical configuration arranged about a central bore extending between the first and second end caps, a hydrophobic material disposed in the central bore and being operative to separate water from filtered fluid and a water collector located axially outside of the central bore and being arranged for collecting water separated from the filtered fluid.

In accordance with a preferred embodiment of the present invention the filter fluid element also includes a perforated support cylinder disposed in the central bore. Additionally, the filter fluid element also includes a central tube element disposed within the central bore radially interiorly of the perforated support cylinder.

In accordance with a preferred embodiment of the present invention the central tube element includes a top portion, a lower edge, a plurality of azimuthally distributed spacer elements, extending adjacent to the lower edge and defining a water separation region and a bottom portion. Preferably, the bottom portion has a plurality of radially-extending protrusions and a bottom flange. Additionally, the bottom flange defines a seat for a sealing ring.

In accordance with a preferred embodiment of the present invention the second end cap includes a radially-inwardly extending recess. Additionally, the radially-inwardly extending recess includes a pair of mutually facing snap fit engagement recesses and a pin seating protrusion.

Preferably, the water separator includes a cylindrical mesh of hydrophobic fabric. In accordance with a preferred embodiment of the present invention the water separator is mounted onto the central tube element at the water separation region.

In accordance with a preferred embodiment of the present invention the hydrophobic material includes a cylindrical mesh of hydrophobic fabric.

Preferably, the hydrophobic material is positioned onto the central tube element at the water separation region.

### BRIEF DESCRIPTION OF THE DRAWINGS

The present invention will be understood and appreciated more fully from the following detailed description, taken in conjunction with the drawings in which:

FIG. 1 is a simplified side view illustration of a filter element constructed and operative in accordance with a preferred embodiment of the present invention;

FIG. 2 is a simplified sectional view illustration of the filter element of FIG. 1, taken along the lines II-II in FIG. 1;

FIG. 3 is a simplified exploded view illustration of the filter element of FIGS. 1 and 2;

FIG. 4 is a simplified pictorial illustration of a filter medium forming part of the filter element of FIGS. 1-3;

FIG. 5 is a simplified pictorial illustration of a hydrophobic mesh element forming part of the filter element of FIGS. 1-3;

FIG. 6 is a simplified illustration of a central tube element forming part of the filter element of FIGS. 1-3;

FIG. 7 is a simplified illustration of a lower end disc element forming part of the filter element of FIGS. 1-3;

FIG. 8 is a simplified illustration of a plug element mounted on the lower end cap element and forming part of the filter element of FIGS. 1-3;

FIG. 9 is a simplified illustration of a sealing ring mounting element, forming part of the filter element of FIGS. 1-3; and

FIGS. 10A, 10B and 10C are simplified illustrations of a water collection element mounted on the lower end cap element and forming part of the filter element of FIGS. 1-3.

### DETAILED DESCRIPTION OF A PREFERRED EMBODIMENT

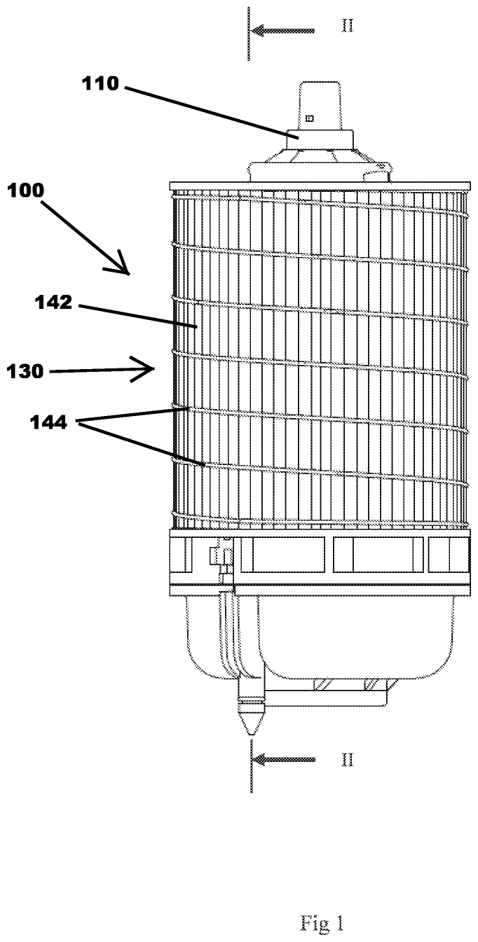

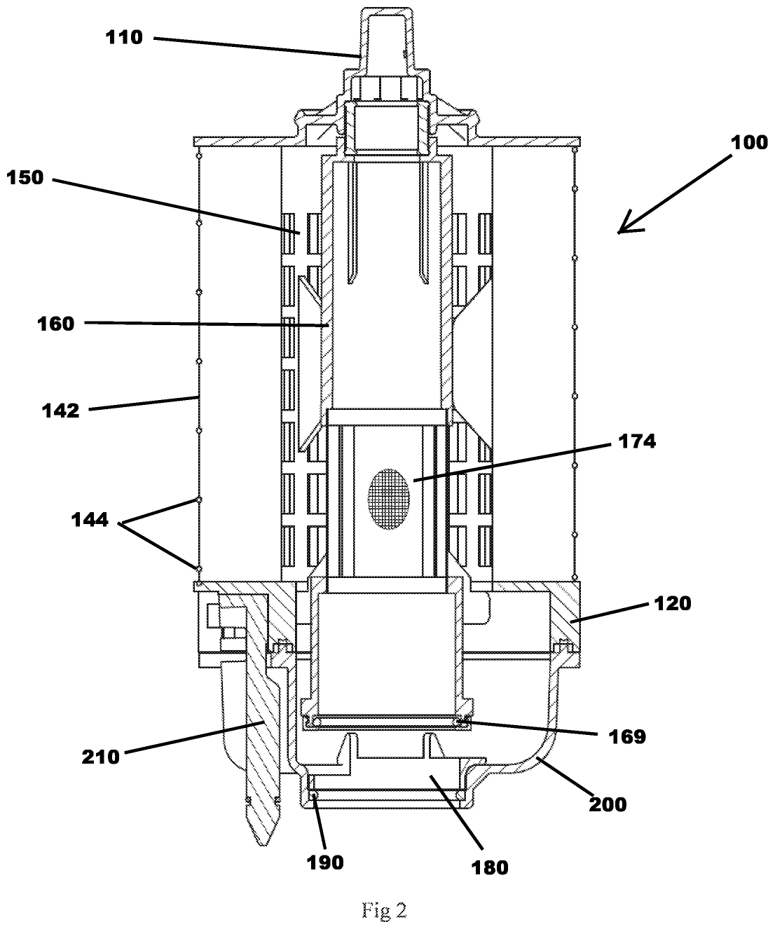

Reference is now made to FIGS. 1-10C, which illustrate a fluid filter 100, constructed and operative in accordance with a preferred embodiment of the present invention.

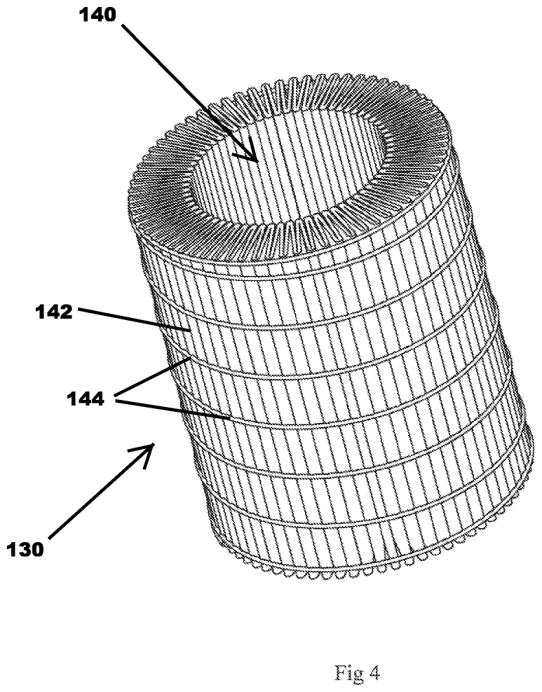

Turning initially to FIGS. 1-3, it is seen that the fluid filter 100 comprises first and second end caps 110 and 120 respectively and a filter medium 130 joined, preferably by heat welding, to the first and second end caps 110 and 120 and defining a cylindrical accordion-like configuration arranged about a central bore 140 extending between first and second end caps 110 and 120. Filter medium 130 is shown in FIG. 4. As seen in FIG. 4, filter medium 130 preferably comprises pleated filter sheet material 142 arranged in a circular cylindrical configuration about central bore 140, which is surrounded by a wound reinforcing wire 144.

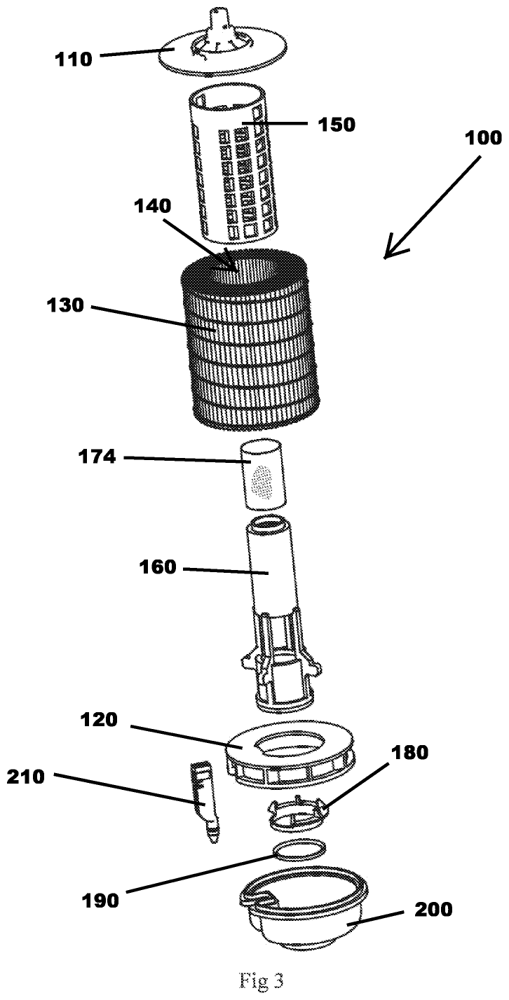

Disposed in the central bore 140 is a perforated support cylinder 150 and disposed within central bore 140 radially interiorly of support cylinder 150 is a central tube element 160, preferably as shown in FIG. 6. Central tube element 160 is a generally elongate element, preferably integrally formed of plastic and includes a top portion 161, in the sense of FIG. 3, having a top flange 162, which lies adjacent first end cap 110, and a lower edge 163, adjacent to which extend a plurality of azimuthally distributed spacer elements 164, defining a water separation region 165. Below water separation region 165 is provided a bottom portion 166, having a plurality of radially-extending protrusions 167, and a bottom flange 168, defining a seat for a sealing ring 169. Protrusions 167 define the mutual axial seating orientation of the central tube element 160 and the second end cap 120.

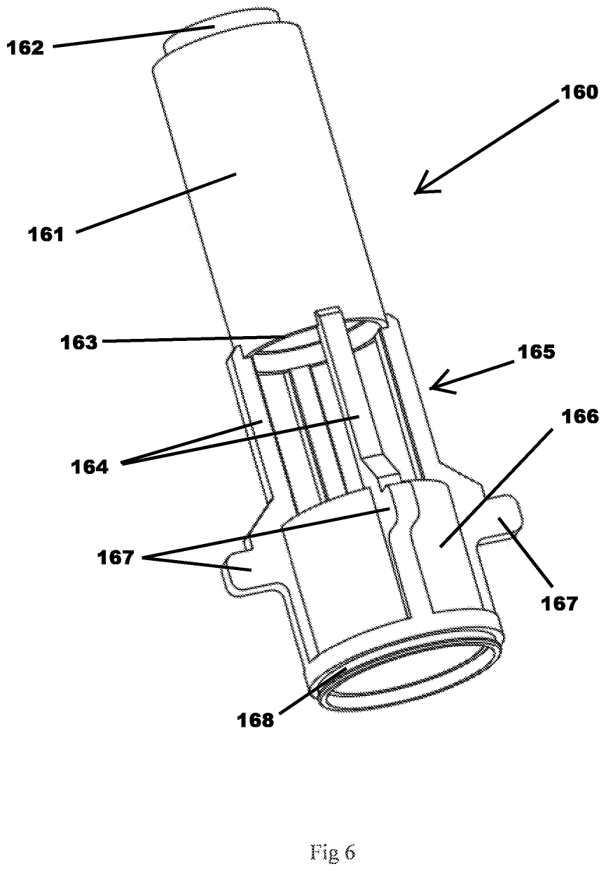

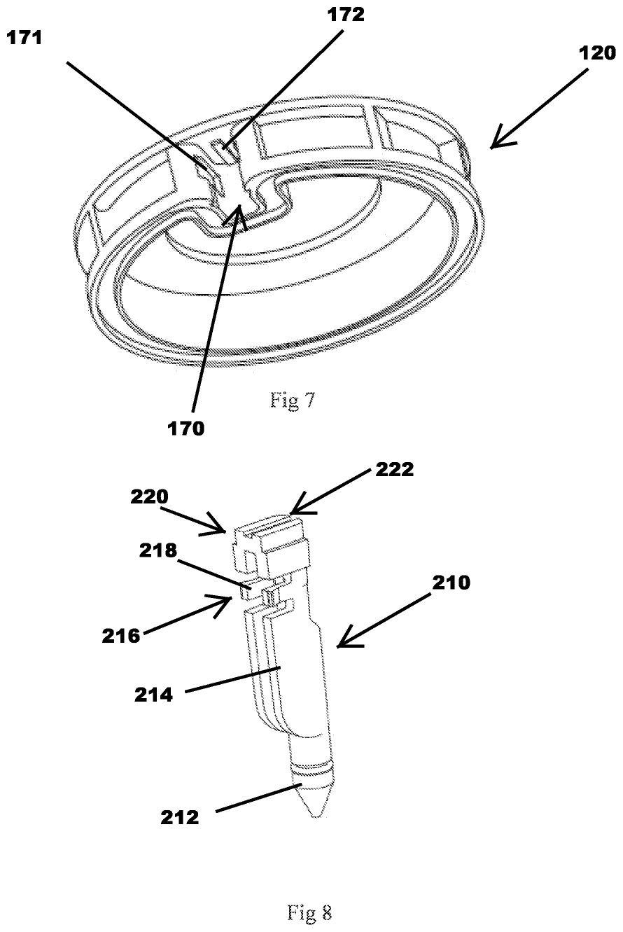

Second end cap 120 is shown in FIG. 7 and is seen to be configured in a generally circular cylindrical configuration and to have a radially-inwardly extending recess 170 formed therein. Recess 170 is preferably formed with a pair of mutually facing snap fit engagement recesses 171 and a pin seating protrusion 172.

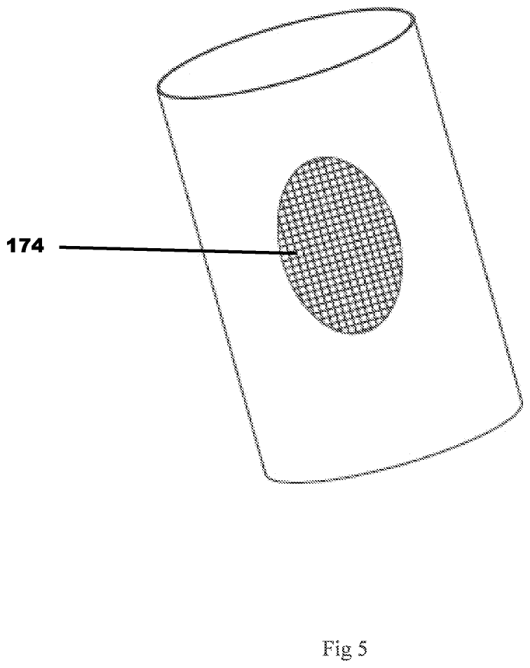

A hydrophobic water separator 174, preferably in the form of a cylindrical mesh of hydrophobic fabric, as shown in FIG. 5, is mounted onto central tube element 160 at water separation region 165.

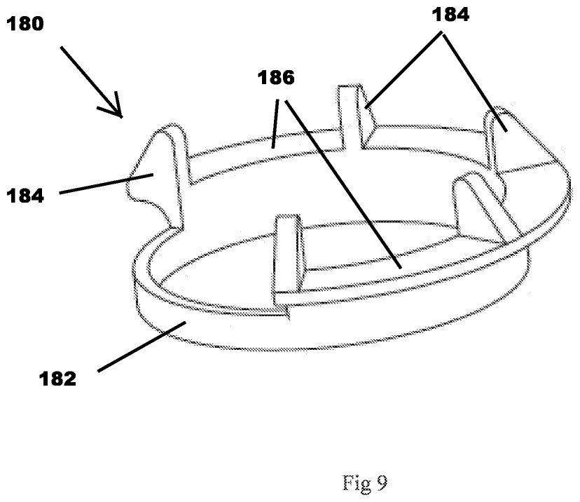

A sealing ring retaining element 180 is illustrated in FIG. 9 and is seen to include a generally circular ring portion 182 and a plurality of azimuthally distributed protrusions 184 extending axially upwardly, in the sense of FIG. 3, from a flange 186. Sealing ring retaining element 180 is operative to retain a sealing ring 190 in a water collector 200.

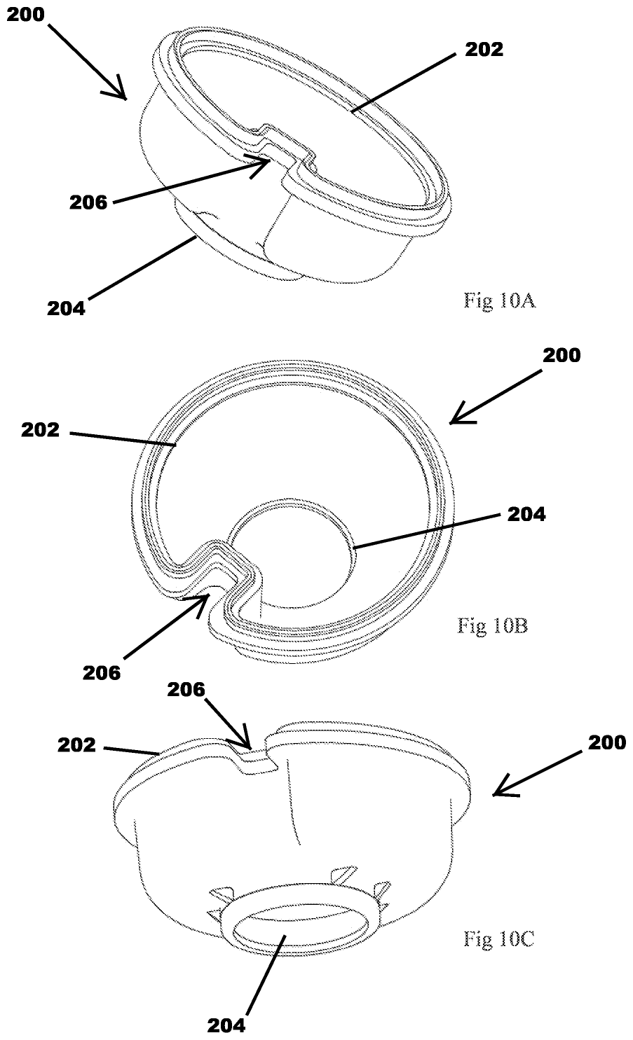

Water collector 200 is arranged for collecting water separated from filtered fluid. The water collector 200 is preferably located outside of the central bore 140 defined between the first and second end caps 110 and 120 and is axially outside second end cap 120. Water collector 200 is illustrated in FIGS. 10A, 10B and 10C and is seen to be a generally circular cup having a relatively large top opening 202 and a relatively small central bottom opening 204. Water collector 200 is preferably formed with a radially-inwardly extending recess 206 which is preferably aligned with a radially-inwardly extending recess 170 of second end cap 120. Sealing ring mounting element 180 is pressure fit interiorly of water collector 200 surrounding opening 204 to retain sealing ring 190 therein.

A plug 210 is mounted on the second end cap 120 and is separate from the water collector 200 and is configured for selective blocking of a selectably blockable outlet channel (not shown), such as that described in U.S. Pat. No. 9,333,448, the disclosure of which is hereby incorporated by reference, when fluid filter element 100 is mounted in a suitable filter housing, such as that described in U.S. Pat. No. 9,333,448, in an operative orientation.

Plug 210 is illustrated in FIG. 8 and includes a sealing ring mounting pin portion 212, which is configured for selectable sealing engagement with the selectably blockable outlet channel referenced above. Extending above pin portion 212, in the sense of FIG. 3, is a main portion 214 which extends upwardly to a snap-fit mounting portion 216, preferably including a pair of mutually oppositely facing snap fit fingers 218, which are arranged for normally non-removably snap fit engagement with corresponding ones of mutually facing snap fit engagement recesses 171 formed in recess 170 of the second end cap 120. Disposed above snap-fit mounting portion 216 is a seating portion 220 having a top-facing recess 222 which is seated onto correspondingly-shaped pin seating protrusion 172 of the second end cap 120.

It will be appreciated by persons skilled in the art that the present invention is not limited by what has been particularly shown and described hereinabove. Rather, the scope of the present invention includes both combinations and subcombinations of various features described hereinabove and modifications and variations thereof which are not in the prior art.

1. A fluid filter element for use with a filter housing having a selectably blockable outlet channel for unfiltered fluid, the fluid filter element comprising:
first and second end caps;
a filter medium joined to said first and second end caps and defining a cylindrical configuration arranged about a central bore extending between said first and second end caps;
a water separator operative to separate water from filtered fluid;
a water collector arranged for collecting water separated from said filter fluid; and
a plug mounted on said second end cap and separate from said water collector and being configured for selective blocking of said selectably blockable outlet channel, when said fluid filter element is mounted in said filter housing in an operative orientation.

2. A filter fluid element according to claim 1 and also comprising a perforated support cylinder disposed in said central bore.

3. A filter fluid element according to claim 2 and also comprising a central tube element disposed within said central bore radially interiorly of said perforated support cylinder.

4. A filter fluid element according to claim 3 and wherein said central tube element comprises:
a top portion;
a lower edge;
a plurality of azimuthally distributed spacer elements, extending adjacent to said lower edge and defining a water separation region; and
a bottom portion.

5. A filter fluid element according to claim 4 and wherein said bottom portion has a plurality of radially-extending protrusions and a bottom flange.

6. A filter fluid element according to claim 5 wherein said bottom flange defines a seat for a sealing ring.

7. A filter fluid element according to claim 1 and wherein said second end cap includes a radially-inwardly extending recess.

8. A filter fluid element according to claim 7 and wherein said radially-inwardly extending recess includes a pair of mutually facing snap fit engagement recesses and a pin seating protrusion.

9. A filter fluid element according to claim 1 and wherein said water separator comprises a cylindrical mesh of hydrophobic fabric.

10. A filter fluid element according to claim 4 and wherein said water separator is mounted onto said central tube element at said water separation region.

11. A fluid filter element comprising:
first and second end caps;
a filter medium joined to said first and second end caps and defining a cylindrical configuration arranged about a central bore extending between said first and second end caps;
a hydrophobic material disposed in said central bore and being operative to separate water from filtered fluid; and
a water collector located axially outside of said central bore and being arranged for collecting water separated from said filtered fluid.

12. A filter fluid element according to claim 11 and also comprising a perforated support cylinder disposed in said central bore.

13. A filter fluid element according to claim 12 and also comprising a central tube element disposed within said central bore radially interiorly of said perforated support cylinder.

14. A filter fluid element according to claim 13 and wherein said central tube element comprises:
a top portion;
a lower edge;
a plurality of azimuthally distributed spacer elements, extending adjacent to said lower edge and defining a water separation region; and
a bottom portion.

15. A filter fluid element according to claim 14 and wherein said bottom portion has a plurality of radially-extending protrusions and a bottom flange.

16. A filter fluid element according to claim 15 wherein said bottom flange defines a seat for a sealing ring.

17. A filter fluid element according to claim 11 and wherein said second end cap includes a radially-inwardly extending recess.

18. A filter fluid element according to claim 17 and wherein said radially-inwardly extending recess includes a pair of mutually facing snap fit engagement recesses and a pin seating protrusion.

19. A filter fluid element according to claim 11 and wherein said hydrophobic material comprises a cylindrical mesh of hydrophobic fabric.

20. A filter fluid element according to claim 14 and wherein said hydrophobic material is positioned onto said central tube element at said water separation region.
